(19) United States
(12) Patent Application Publication
(10) Pub. No.: US 2008/0229637 A1
(43) Pub. Date: Sep. 25, 2008

(54) BILLBOARD SYSTEM

(76) Inventor: Sergey Joukov, Zoran (IL)

Correspondence Address: YORAM TSIVION, P.O. BOX 1307, PARDES HANNA, 37111, IL

(21) Appl. No.: 12/111,990

(22) Filed: Jun. 15, 2008

Related U.S. Application Data
(63) Continuation-in-part of application No. PCT/IL2005/001137, filed on Oct. 31, 2005.

(51) Int. Cl. G09F 15/00

(52) U.S. Cl. 40/606.01

(57) ABSTRACT

The disclosure provides a billboard that rotates between display positions and has several sides including each rotating elements which display a different image at each display position.

### CROSS-REFERENCE TO RELATED APPLICATIONS

This patent application is a continuation-in-part of U.S. patent application Ser. No. 12/092,080 filed 30 Apr. 2008, entitled “BILLBOARD SYSTEM”, which is a National Phase Application of International Patent Application Ser. No. PCT/IL2005/001137 filed 31 Oct. 2005, entitled “BILLBOARD SYSTEM”, and published under International Publication Number WO 2007/052244 A2.

The aforementioned applications are incorporated herein in their entirety by this reference.

### BACKGROUND

The present disclosure relates to billboards and more specifically to billboards capable of presenting a plurality of posters or advertisements.

International patent application No. PCT/IL2005/001137, the disclosure of which is incorporated herein by reference, is in the name of the same inventor. In the application is described a billboard that has two or more prism shaped elements and means for their rotation.

### SUMMARY

The following embodiment and aspects thereof are described and illustrated in conjunction with systems, tools and methods which are meant to be exemplary and illustrative, not limiting in scope.

In an embodiment a billboard has a main axis and at least two display axes defining each a display direction therealong, the billboard comprises a side for each display axis, wherein in a display position of the billboard each side faces a display direction, each side comprises at least one element that is associated therewith, the element having a minor axis and comprising at least two surfaces, wherein in the display position of the billboard one surface of each element faces the same direction as its associated side, and wherein when the billboard rotates about the main axis each element rotates about its minor axis.

Typically, the main axis is generally parallel in relation to each minor axis and generally perpendicular in relation to each display axis.

Preferably, the billboard extends along the main axis and each element extends along its minor axis and the sides are symmetrically distributed about the main axis and the surfaces of each given element are symmetrically distributed about the minor axis of the given element.

Typically, the rotation of the billboard about the main axis is synchronized with the rotation of each element about its minor axis.

Optionally the rotation of the billboard about the main axis mechanically urges the rotation of each element about its minor axis.

In addition to the exemplary aspects and embodiment described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 shows a perspective top view of a billboard in accordance with the present disclosure; and

FIG. 2 shows a bottom view of the billboard.

FIG. 3 shows a bottom view of some preferred embodiment of the billboard characterized by having reciprocally rotating elements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

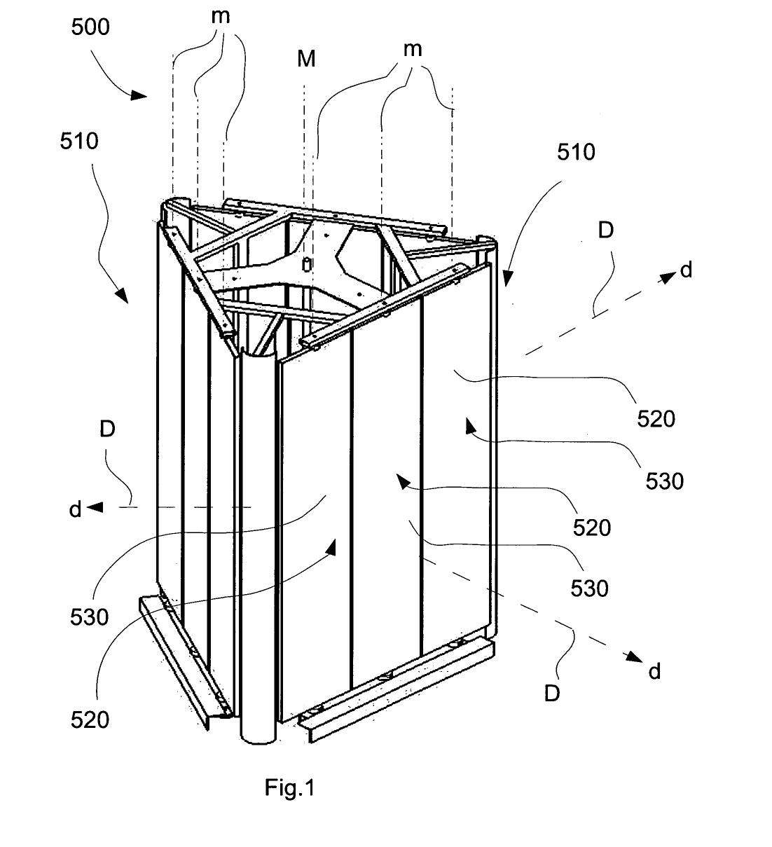

Attention is first drawn to FIG. 1. In an embodiment, a billboard 500 has a main axis of rotation M and three display axes D. Each display axis D perpendicularly intersects the main axis M and defines a display direction d extending therealong in a direction away from the main axis M. The display axes D are symmetrically distributed about the main axis M.

The billboard 500 extends along the main axis M between two ends and has three sides 510 that are symmetrically distributed about the main axis M. Each side 510 has three elements 520. It should be noted that directional terms appearing throughout the specification and claims are for illustrative purposes only, and are not intended to limit the scope of the appended claims. In addition it is noted that the display axes D are fixed in relation to the environment in which the billboard is placed and therefore do not rotate with the billboard 500.

Each element 520 has a minor axis of rotation m and two flat surfaces 530. The surfaces 530 face opposing directions that are each perpendicular to the minor axis m. The surfaces 530 are symmetrically distributed about the minor axis m.

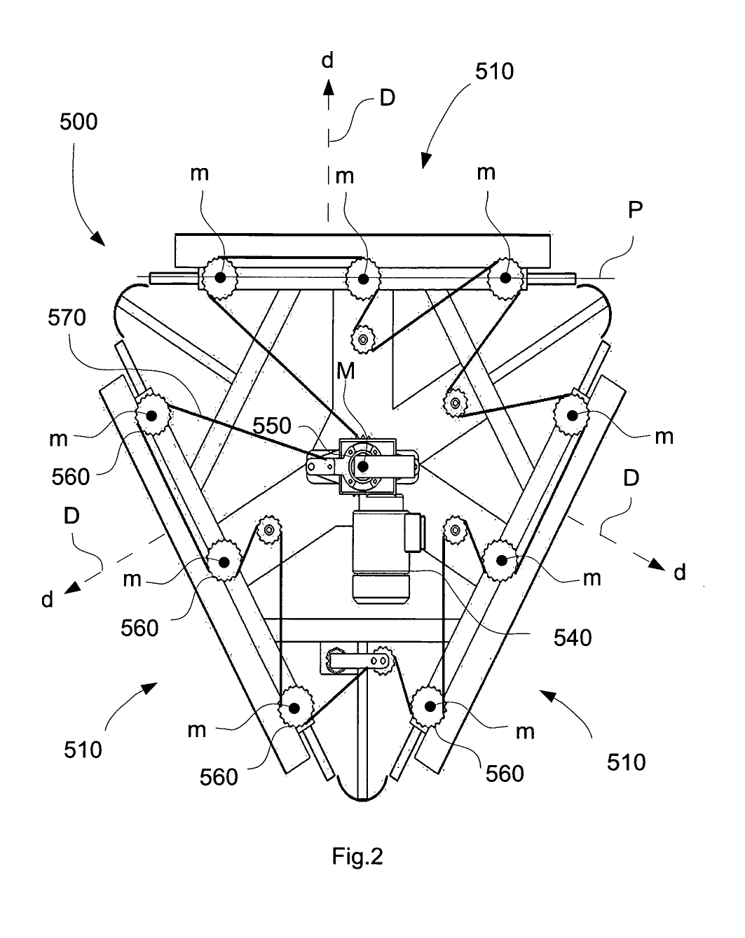

Attention is now additionally drawn to FIG. 2. The billboard 500 has at one of its ends a motor 540 that is adapted to rotate a main rotating means 550 that is integrally connected to the billboard 500. The main rotating means 550 is optionally in the form of a sprocket having a circumference C and the main axis M of the billboard 500 passes through main rotating means 550. At the same end, the billboard 500 has nine minor rotating means 560 that are integrally attached each to a respective element 520. Each minor rotating means 560 is optionally in the form of a sprocket having a circumference c and the minor axis m of each element 520 passes through its minor rotating means 560. Optionally, a continuous belt 570 of the billboard 500, in the form of a chain, extends from the main rotating means 550 through all the minor rotating means 560 and back to the main rotating means 550.

In a display position of the billboard 500 (as shown in FIGS. 1 and 2), each element 520 of a given side 510 has one operative surface 530 that is parallel to an imaginary plane P which includes the minor axes m of the given side 510 and faces out of the billboard. The imaginary plane P is also perpendicular to the display axis D of the given side 510. This means that in the display position, each element 520 has one operative surface 530 that faces the display direction d of the given side 510 and jointly forms together with the other operative surfaces of the given side 510 an image or advertisement which is displayed in the display direction d.

During use, the motor 540 rotates the main rotating means 550 and thereby the billboard 500 about the main axis M between display positions. The belt 570 transfers this rotational movement via the minor rotating means 560 to each element 520 which is thereby urged to rotate about its minor axis m. It is noted that, each time the billboard 500 completes a rotation of 120° about the main axis M and reaches a new display position, each element 520 completes a rotation of 180° about its minor axis m. Therefore, each time the billboard 500 reaches a new display position, each side 510 of the billboard 500 has a new set of operative surfaces 530 that face and jointly display a new image or advertisement in each display direction d. In the embodiment just described, in order to synchronize between the rotation of the billboard 500 about the main axis M and each element 520 about its minor axis m; the circumferences of the main and minor rotating means 550, 560 have a relation of C=1.5c.

It is noted that instead of the belt 570, other means may be used in order to synchronize between the rotation of the billboard 500 about the main axis M and the rotation of each element 520 about its minor axis m. For example, the minor rotation means may be in the form of small motors which are synchronized to rotate in relation to the motor 540 by a controller (not shown).

In embodiments of the disclosure, the billboard 500 may have two or more sides 510 or display axes D and each element 520 may have two or more surfaces 530. For example, the billboard 500 may have a number of sides equal to “i” and each element may have a number of surfaces equal to “j” (“i” and “j” being equal to or larger than two). In these embodiments, the circumferences of the main and minor rotating means 550, 560 comply with a more general relation of C=j/i*c.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb. Although the present embodiment has been described to a certain degree of particularity, it should be understood that various alterations and modifications could be made without departing from the scope of the disclosure as hereinafter claimed.

### BEST MODE FOR CARRYING OUT THE INVENTION

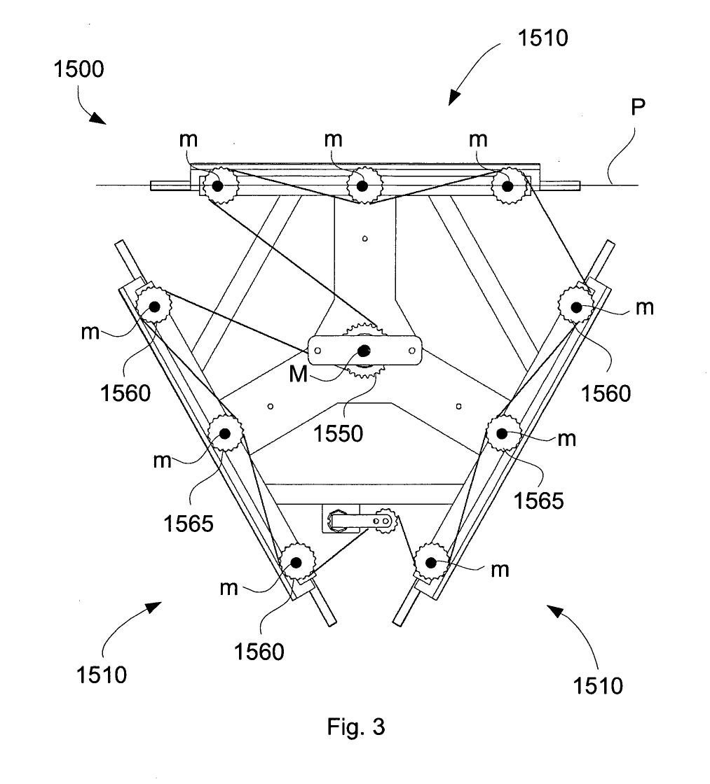

Attention is now drawn to FIG. 3. The billboard 1500 has a main rotating means 1550 that is integrally connected to the billboard 1500. The main rotating means 1550 is in the form of a sprocket having a circumference C and the main axis M of the billboard 1500 passes through main rotating means 1550. The billboard 1500 has six minor flanking rotating means 1560 and three central minor rotating means 1565 that are integrally attached each to respective element, such as the elements 520 shown in FIG. 1.

In a display position of the billboard 1500 (as shown in FIGS. 1 and 3), each element 520 of a given side 1510 has one operative surface 530 that is parallel to an imaginary plane P which includes the minor axes m of the given side 1510 and faces out of the billboard.

Each minor flanking rotating means 1560 and central minor rotating means 1565 are in the form of a sprocket having a circumference c and the minor axis m of each element 520 passes through its respective flanking rotating means 1560 or central minor rotating means 1565. The continuous belt 1570 of the billboard 1500, extends from the main rotating means 1550 through the first flanking rotating means 1560 on a given side 1510 and then through the central minor rotating means 1565 on the same side and following that through the second flanking rotating means 1560 on the same side; the continuous belt 1570 extends through the flanking rotating means 1560 on a given side 1510 and then through the respective central minor rotating means 1565 on the same side, engaging the opposite circumferential portions of rotating means 1560 and rotating means 1565, thereby applying a reciprocal rotational torque to the rotating means 1565. The rotational torque conveyed by the central minor rotating means 1565 through a minor axis m to the respective element 520 rotates it in an opposite direction than the flanking elements 520 connected to the respective flanking rotating means 1560 on the same side of billboard 1500. This reciprocal rotational torque provides for a unique display experience for the viewer and furthermore for a more stable retention of a signboard sheet adhesively attached to the elements 520 of imaginary plane P; since the adjacent elements 520 rotate reciprocally and do not decorticate the flanks of the adhesively attached signboard sheet from adjacent element.

1. A billboard having a main axis and at least two display axes defining each a display direction therealong,
the billboard comprises a side for each display axis, wherein in a display position of the billboard each side faces a display direction,
each side comprises at least one element that is associated therewith, the element having a minor axis and comprising at least two surfaces, wherein
in the display position of the billboard one surface of each element faces the same direction as its associated side, and wherein
when the billboard rotates about the main axis each element rotates about its minor axis.

2. A billboard according to claim 1, wherein the main axis is generally parallel in relation to each minor axis and generally perpendicular in relation to each display axis.

3. A billboard according to claim 1, wherein the billboard extends along the main axis and each element extends along its minor axis.

4. A billboard according to claim 3, wherein the sides are symmetrically distributed about the main axis and the surfaces of each given element are symmetrically distributed about the minor axis of the given element.

5. A billboard according to claim 1, wherein the rotation of the billboard about the main axis is synchronized with the rotation of each element about its minor axis.

6. A billboard according to claim 1, wherein the rotation of the billboard about the main axis mechanically urges the rotation of each element about its minor axis.

7. A billboard according to claim 6, wherein the billboard has a main rotating means, each element has a minor rotating means and a belt of the billboard that communicates with the major and minor rotating means urges each element to rotate during rotation of the billboard.

8. A billboard according to claim 7, wherein the main rotating means is in the form of a sprocket having a circumference C and each minor rotating means is in the form of a sprocket having a circumference c.

9. A billboard according to claim 8, wherein the billboard has a number of sides equal to “i” and each element has a number of surfaces equal to “j” and “i” and “j” are equal to or greater than two.

10. A billboard according to claim 9, wherein C=i/j*c.

11. A billboard according to claim 1, wherein each surface comprises at least a portion of an image or an advertisement to be displayed at a display position in a display direction.

12. A billboard according to claim 1, wherein each side has an imaginary plane which includes the minor axes of the side and in the display position of the billboard each imaginary plane perpendicularly intersects a display axis.

13. A billboard according to claim 1, wherein said at least one element comprises three elements for each of the three asides, and wherein the central element of said three elements rotates reciprocally to the adjacent flanking element.
